(19) United States
(12) Patent Application Publication
(10) Pub. No.: US 2013/0226654 A1
(43) Pub. Date: Aug. 29, 2013

(54) PLANT-CULTIVATION CONTROL SYSTEM AND CONTOL METHOD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/571,377

(22) Filed: Aug. 10, 2012

(30) Foreign Application Priority Data
Feb. 23, 2012 (TW) 101105955

(51) Int. Cl. G06Q 30/02

(52) U.S. Cl. 705/7.29

(57) ABSTRACT

A plant-cultivation control method includes: receiving a number of types of agricultural products and quantities of each type inputted by a first user, and storing the information in a memory. Receive a desired type and desired quantity of the desired type inputted by a second user. Querying available quantity of the desired type, and determine if the available quantity is at least equal to the desired quantity. Indicate to the second user to adjust plan when the available quantity is less than the desired quantity. Indicate to the second user to select updating or not updating the quantity remaining when the available quantity is more than or equal to the desired quantity. Subtracting the desired quantity from the available quantity when the second user selects updating and storing the updated available quantity in the memory. A plant-cultivation control system is also provided.

### BACKGROUND

1. Technical Field

The present disclosure relates to a plant-cultivation control system and control method.

2. Description of Related Art

Relationship between supply and demand is affected by sale prices of agricultural products. As the types and quantity of agricultural products are difficult to control, the relationship between supply and demand of agricultural products is often imbalanced, which leads to unstable prices. For example, when the price of certain type of agricultural product increases, next year the quantity of the certain type of agricultural products will increase, which will result in excessive output in the following years.

Therefore, it is desirable to provide a plant-cultivation control system and control method, which can at least alleviate the above-mentioned issue.

### BRIEF DESCRIPTION OF THE DRAWINGS

FIG. 1 is a functional block diagram of a plant-cultivation control system according to an embodiment.

FIG. 2 is a flowchart of a plant-cultivation control method, according to an embodiment.

### DETAILED DESCRIPTION

Embodiments of the disclosure will be described with reference to the accompanying drawings.

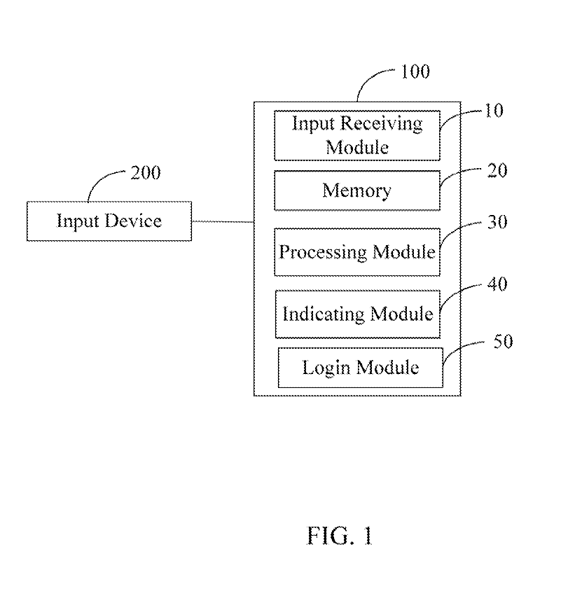

Referring to FIG. 1, a plant-cultivation control system 100 is disclosed, according to an embodiment, which can be employed and run in a network server, and which can communicate with input devices 200 such as mobile phones, computers and other clients through a network.

The plant-cultivation control system 100 is used to preset a predetermined number of types of agricultural products and the total quantity of each type by a first user. The quantity of types of agricultural products and the total quantity of each type are determined according to a relationship between supply and demand.

The plant-cultivation control system 100 is also used for a second user to input a desired type and a desired quantity of the type, query an available quantity of the desired type, indicate to the second user to adjust plan when the available quantity of the desired type is less than the desired quantity of the desired type, and update the available quantity of the desired type by subtracting the desired quantity when the available quantity of the desired type is equal to or more than the desired quantity of the desired type.

The plant-cultivation control system 100 includes an input receiving module 10, a storing module 20, a processing module 30, and an indicating module 40.

The input receiving module 10 receives the types of agricultural products and the total quantity of each type of the agricultural products inputted by the first user, and stores the information in the memory 20. The input receiving module 10 further receives one desired type of agricultural product and the desired quantity inputted by the second user. The input receiving module 10 can provide an interface to the input devices 200 via a network to invite the first user and the second user to enter input.

The processing module 30 queries the available quantity of the desired type, determines if the available quantity of the desired type is more than or equal to the desired quantity of the desired type. The processing module 30 generates a first signal when the available quantity of the desired type is less than that desired quantity of the desired type and generates a second signal when the available quantity of the desired type is at least equal to the desired quantity of the desired type.

The indicating module 40 invites the second user to adjust plan when receiving the first signal, and invites the second user to select updating or not updating the currently available quantity of the desired type, when receiving the second signal. If the second user selects to update the currently available quantity of the desired type, the processing module 30 makes a determination by subtracting the desired quantity from the currently available quantity of the desired type, and then stores the updated available quantity of the desired type in the memory 20.

In another embodiment, the memory 20 further stores information of a number of second users and the first users. The plant-cultivation control system 100 further includes a login module 50 to generate a login interface to indicate to input account and password. The login module 50 determines if the inputted account and password are already stored in the memory 20, and allows entry into the plant-cultivation control system 100 when the inputted account and password is already stored in the memory 20.

In another embodiment, the input receiving module 10 can receive sale prices of the plurality of types of agricultural products uploaded or inputted by the second user and stores the sale prices in the memory 20. The input receiving module 10 can further preset a range of reasonable sale prices of each type in the memory 20. The processing module 30 queries the sale price of the desired type of agricultural product, compares the sale price of the desired type with the range of reasonable sale prices, and generates a third signal when the sale price of the desired type is not within the range of reasonable sale prices. The indicating module 40 indicates that the sale price of the desired type is abnormal when the third signal is received.

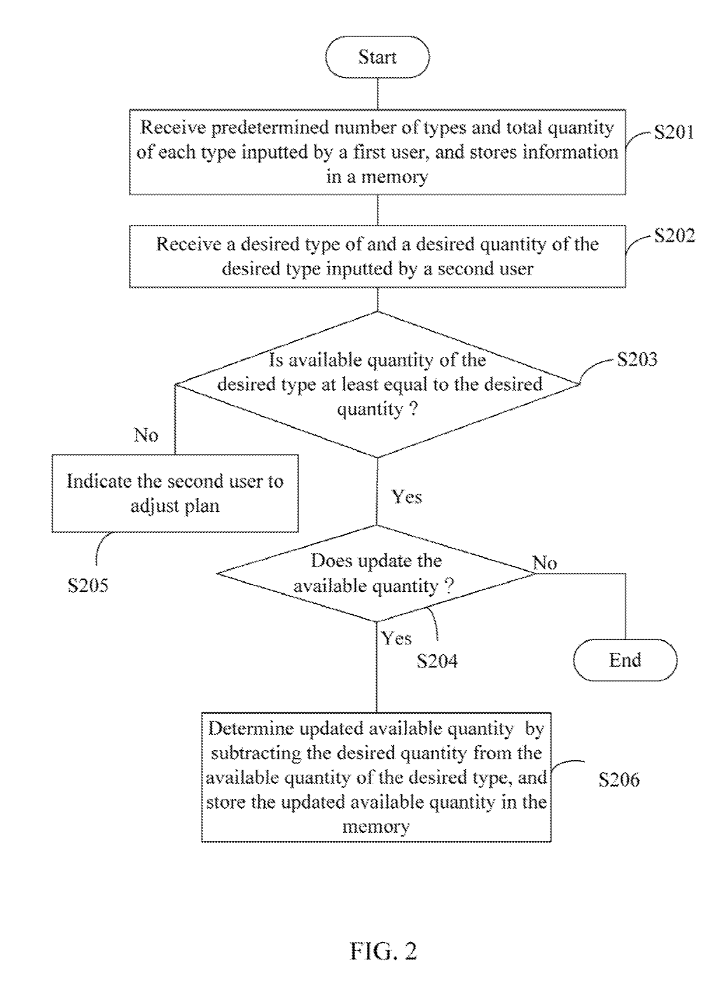

Referring to FIG. 2, a plant-cultivation control method, according to an embodiment, can be implemented on the plant-cultivation control system 100 and includes the following steps.

In step S201, the input receiving module 10 presets the predetermined number of types of agricultural products and the total quantity of each type by the first user, and stores the types and quantities of agricultural products in the memory 20.

In step S202, the input receiving module 10 one desired type of agricultural product and the desired quantity inputted by the second user.

In step S203, the processing module 30 queries the available quantity of the desired type, and determines if the available quantity of the desired type is at least equal to the quantity desired. If no, the procedure goes to step S205, if yes, the procedure goes to step S204.

In step S204, the indicating module 40 invites the second user to select whether to update the available quantity of the desired type when the second signal is received. If yes, the procedure goes to S206, if no, the procedure ends.

In step S205, the indicating module 40 indicates to the second user to adjust plan.

In step S206, the processing module 30 updates the available quantity of the desired type by subtracting the desired quantity from the available quantity, and stores the updated available quantity in the memory 20.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A plant-cultivation control system connected with one or more input devices, comprising:
a memory,
an input receiving module, to receive a number of predetermined types of agricultural products and total quantity of each type inputted by a first user via the input devices, store the predetermined types and the total quantity of each type in the memory, receive a desired type of agricultural products and desired quantity of the desired type inputted by a second user;
a processing module, to query available quantity of the desired type, determine if the available quantity of the desired type is more than or equal to the desired quantity of the desired type, generate a first signal when the available quantity of the desired type is less than the desired quantity of the desired type and generate a second signal when the available quantity of the desired type is more than or equal to the desired quantity of the desired type; and
an indicating module, to indicate the second user to adjust plan when the first signal is received, and invite the second user to select whether to update the available quantity of the desired type when the second signal is received;
wherein when the second user selects to update the available quantity of the desired type, the processing module determines the updated available quantity of the desired type by subtracting the desired quantity from the available quantity of the desired type, and stores the updated available quantity in the memory.

2. The plant-cultivation control system according to claim 1, wherein the input receiving module provides an interface to the input devices via network to invite the first user and the second user to input data.

3. The plant-cultivation control system according to claim 1, wherein the memory further stores information of a number of second users and the first users, the plant-cultivation control system further comprises a login module to generate a login interface to indicate to input account and password, determine if the inputted account and password are already stored in the memory, and enter into the plant-cultivation control system when the inputted account and password is already stored in the memory.

4. The plant-cultivation control system according to claim 3, wherein the input receiving module receives sale prices of the plurality of types of agricultural products uploaded or inputted by the second user and stores the sale prices in the memory, presets a range of reasonable sale prices of each type in the memory, queries the sale price of the desired type of agricultural product, compares the sale price of the desired type with the range of reasonable sale prices, and generates a third signal when the sale price of the desired type is not within the range of reasonable sale prices, the indicating module indicates that the sale price of the desired type is abnormal when the third signal is received.

5. The plant-cultivation control system according to claim 4, wherein the plant-cultivation control system is employed and run in a network server, and communicates with input devices through network.

6. The plant-cultivation control system according to claim 1, wherein the predetermined number of types of agricultural products and the total quantity of each type are determined according to a relationship between supply and demand

7. A plant-cultivation control method applied in a plant-cultivation control system connected with one or more input devices, comprising:
receiving a number of predetermined types of agricultural products and total quantity of each type inputted by a first user via the input devices, store the predetermined types and the total quantity of each type in the memory ;
receiving a desired type of agricultural products and desired quantity of the desired type inputted by a second user;
querying available quantity of the desired type, and determining if the available quantity of the desired type is more than or equal to the desired quantity of the desired type;
indicating the second user to adjust plan when the available quantity of the desired type is less than the desired quantity of the desired type when the second signal is received;
inviting the second user to select whether to update the available quantity of the desired type when the available quantity of the desired type is more than or equal to the desired quantity of the desired type; and
determining updated available quantity of the desired type by subtracting the desired quantity from the available quantity when the second user selects to update the available quantity, and storing the updated available quantity in the memory.

8. The plant-cultivation control method according to claim 7, wherein the method further comprises providing an interface to the input devices via network to invite the first user and the second user to input data.

9. The plant-cultivation control method according to claim 7, wherein the memory further stores information of a number of second users and the first users, the method further comprises: generating a login interface to indicate to input account and password, determining if the inputted account and password are already stored in the memory, and entering into the plant-cultivation control system when the inputted account and password is already stored in the memory.

10. The plant-cultivation control method according to claim 7, wherein the method further comprises:
receiving sale prices of the plurality of types of agricultural products uploaded or inputted by the second user and storing the sale prices in the memory, presetting a range of reasonable sale prices of each type in the memory;
querying the sale price of the desired type of agricultural product, comparing the sale price of the desired type with the range of reasonable sale prices; and
indicating that the sale price of the desired type is abnormal when the sale price of the desired type is not within the range of reasonable sale prices.

11. The plant-cultivation control method according to claim 7, wherein the plant-cultivation control method is implemented on a network server, and communicates with input devices through network.

12. The plant-cultivation control method according to claim 7, wherein the predetermined number of types of agricultural products and the total quantity of each type are determined according to a relationship between supply and demand.
